(19) United States
(12) Patent Application Publication
(10) Pub. No.: US 2003/0110516 A1
(43) Pub. Date: Jun. 12, 2003

(54) System and method for embedding data in broadcast

(75) Inventors: Matthew Chang, San Diego, CA (US); Greg Gudorf, San Diego, CA (US); Aaron Dew, San Diego, CA (US); Anthony Lionel Creed, San Diego, CA (US); Rolf Toft, San Francisco, CA (US)

Correspondence Address: John L. Rogitz, Rogitz & Associates, 750 B Street, Suite 3120, San Diego, CA, 92101, US

(73) Assignees: SONY CORPORATION, Tokyo (JP); SONY ELECTRONICS INC., Park Ridge, NJ

(21) Appl. No.: 09/999,669

(22) Filed: Oct. 31, 2001

(51) Int. Cl. H04N 7/173; G06F 3/00; H04N 5/445; H04N 7/025; H04N 7/10; H04N 7/16; G06F 13/00

(52) U.S. Cl. 725/136; 725/113; 725/51; 725/32

(57) ABSTRACT

A system and method for conveying information pertaining to broadcast content such that the system is robust and stripping or blocking data is rendered relatively difficult. A broadcast component encodes the content with a digital watermark or embeds an icon or other visibly or audibly transparent object (e.g., audio jingle) in the content. A TV or radio that has a microprocessor decodes the content to retrieve the watermark or analyzes the image/jingle to determine an ID. Using the ID a database is accessed to retrieve information pertaining to broadcast content. Alternatively, the watermark may represent the actual data itself. The information can include, e.g., Web site hyperlinks, and/or UPC codes, and/or advertising data.

### BACKGROUND OF THE INVENTION

1. Field of the Invention

The present invention relates generally to broadcast systems such as television and radio systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a 15 computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, in a lean back experience, it might be desirable to enable certain useful data to be embedded in a broadcast that can be extracted by a TV microprocessor and used to, e.g., easily and conveniently provide a viewer with additional information relating to programs or advertised products, without requiring excessive viewer action. As recognized herein, however, simply embedding data in the vertical blanking interval (VBI) of a broadcast might not be robust in some situations, and further might result in degraded performance and even result in the data being lost in systems such as some personal video recorders that may strip the VBI from the television signal.

### SUMMARY OF THE INVENTION

A method for conveying content-related information in a broadcast signal includes imposing a non-VBI (in the TV application) embedding of data in the signal. This can be thought of as imposing a non-VBI enhancement on a broadcast signal. The enhancement is correlatable to information relating to content represented by the signal.

In one embodiment, the non-VBI enhancement is a digital watermark, and the TV signal is encoded using the watermark without degrading the visible or audio TV signal. In another embodiment, the data is an audio watermark such as may be more commonly used for copy protection. The audio is not perceptively degraded and rather than copy protection data, content-related data is encoded. In yet another embodiment, the non-VBI enhancement is an image, and the image is embedded in the TV signal. The image can be an icon or graphic object, such as an MPEG4 object.

In any case, the non-VBI enhancement is identified at a TV and may contain either the actual data encoded in the watermark or may be used in conjunction with a database. In the case of a watermark, the TV signal is decoded or filtered to obtain the watermark signal. In the case of an image or visible icon, the image embedded in the TV signal is analyzed and used as a database pointer. The database holds information selected from the group including Web site hyperlinks, UPC codes, and advertising data, such that this information can be returned for display on the TV. Or, information from the database can be stored on a removable media and conveyed to a computer that might then use a hyperlink to access a related Web site.

In another aspect, a system for conveying information pertaining to broadcast content includes a broadcast component encoding the content with a digital watermark, and a TV including a microprocessor decoding the content to retrieve the watermark. The system also includes a database that is accessible by the microprocessor using the watermark to retrieve the information pertaining to broadcast content therefrom.

In still another aspect, a system for conveying information pertaining to broadcast content includes a broadcast component embedding at least one image in the content, and a TV including a microprocessor analyzing the image. A database is accessible by the microprocessor using the image to retrieve the information pertaining to broadcast content therefrom.

In yet another aspect, a TV for displaying broadcast content and accessing information pertaining to the broadcast content includes a microprocessor decoding the content to retrieve a watermark therefrom. The TV also includes a database that is accessible by the microprocessor using the watermark to retrieve the information pertaining to broadcast content therefrom.

In another aspect, a TV for displaying broadcast content and accessing information pertaining to the broadcast content includes a microprocessor analyzing an image embedded in the content, and a database accessible by the microprocessor using the image to retrieve the information pertaining to broadcast content therefrom.

In another aspect, the object may be an MPEG4 object that is visible to the user.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of an exemplary embodiment of the overall system of the present invention;

FIG. 2 is a block diagram of a broadcast receiving system (such as a TV, radio, etc.) for decoding watermark information;

FIG. 3 is a block diagram of a broadcast receiving system for decoding embedded image information;

FIG. 4 is a flow chart of the inventive logic of the system shown in FIG. 2; and

FIG. 5 is a flow chart of the inventive logic of the system shown in FIG. 3.

### DETAILED DESCRIPTION OF THE PREFERRED EMBODIMENTS

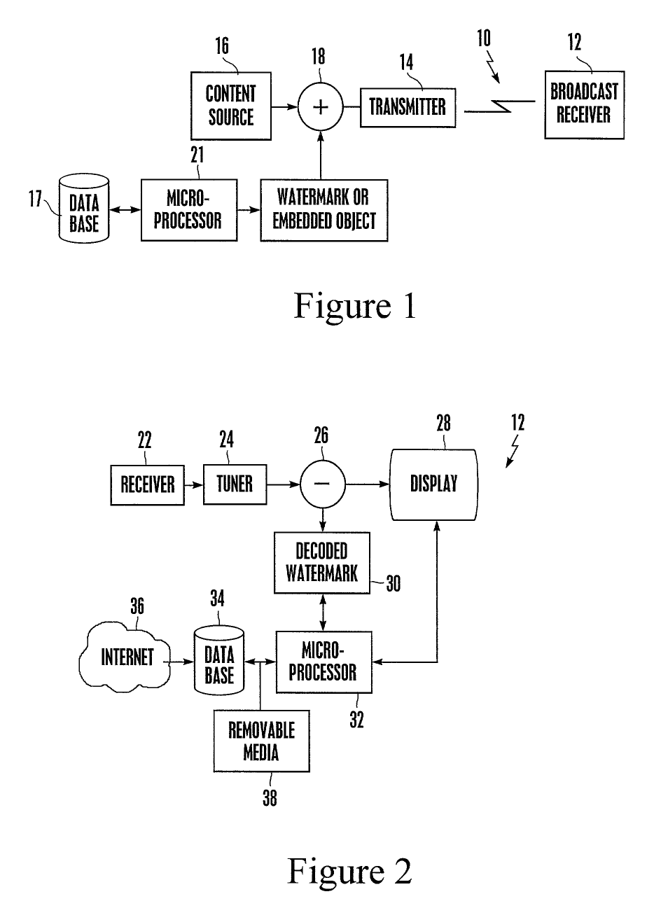

Referring initially to FIG. 1, a system is shown, generally designated 10. As shown, the system 10 includes a broadcast receiver 12 such as a TV or radio that conventionally receives broadcast content from a transmitter 14. The transmitter 14 broadcasts content received from a content provider 16 that is combined, at component 18, with a non-VBI enhancement 20. The non-VBI enhancement 20 can be generated by a processor 21 that may encode data from a database 17 to render the enhancement 20.

By non-VBI enhancement is meant an enhancement to a conventional TV or radio signal in the active video (or audio) area of the signal, either by encoding the content with a digital watermark or by embedding an object such as an image into the active video area of TV content, that does not use the vertical blanking interval of the broadcast. “Non-VBI enhancement” encompasses data that is embedded in the active video area of a TV signal in a non-degrading or imperceptible manner, such as a digital watermark, as well as data that is visible, such as icons. “Non-VBI enhancement” thus encompasses data that is transmitted outside of the VBI in the active video region but potentially outside the “safe” area, i.e., in a border area of the active video area that is generally overscanned by most consumer TV systems. Each program on each channel, as well as each advertisement that is broadcast, can have its own unique non-VBI enhancement.

FIG. 2 shows that in one embodiment, the broadcast receiver 12 can include a content receiver 22 (e.g., an antenna, satellite dish, set-top box, etc.). The receiver 22 receives the broadcast signal and sends it to a tuner 24, which selects a channel in accordance with principles known in the art. The output of the tuner 24 is sent to a decoder 26, which separates the video and/or audio data from the watermark which is then decoded. The content is sent to a display 28 for presentation thereof. The decoder 26 also outputs the watermark 30 to a microprocessor 32. It is to be understood that the decoder 26 can be implemented by the microprocessor 32. In any case, as set forth further below the microprocessor uses the watermark 30 to access a database 34 which can communicate, if desired, with the Internet 36. Data can be output from the microprocessor 32 to a removable media 38, e.g., a Sony Memory Stick® or Smart File® which is removably engageable with a slot in the receiver 12.

It is to be understood that the term “television” encompasses any apparatus that has a television tuner and the below-described functionality in a single housing or in separate housings that cooperate together. For instance, the term “TV” encompasses the television system shown, as well as a conventional television in combination with a set-top box that functions in accordance with the present invention.

The microprocessors/processors disclosed herein execute the logic set forth in the flow charts. The microprocessors/processor can access data storages such as the database 34 that are contained in computer memory, or on a hard disk drive, optical drive, solid state storage, tape drive, removable flash memory, or any other suitable data storage medium and potentially accessible to a network such as the Internet.

It is to be understood that the microprocessors disclosed herein function in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by the present microprocessors/processors as a series of computer-executable instructions. In addition to residing on hard disk drives, these instructions may reside, for example, in RAM of the appropriate computer, or the instructions may be stored on magnetic tape, electronic read-only memory, or other appropriate data storage device.

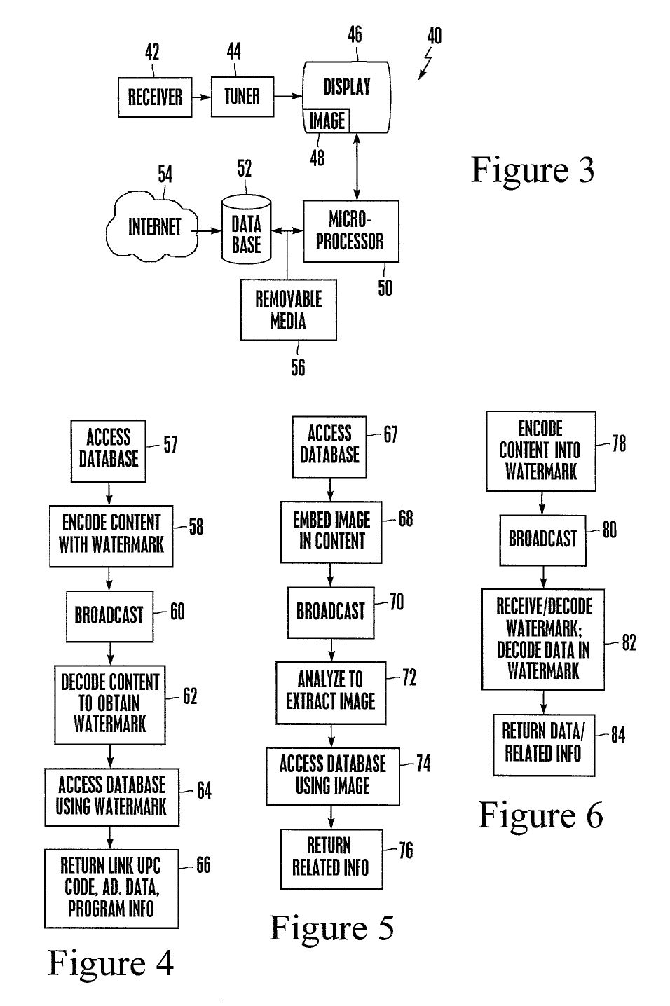

FIG. 3 shows another embodiment of the present broadcast receiver, e.g., a TV, generally designated 40. As shown, the broadcast receiver 40 includes a content receiver 42 (e.g., an antenna, satellite dish, set-top box, etc.). The receiver 42 receives the broadcast signal and sends it to a tuner 44, which selects a channel in accordance with principles known in the art. The output of the tuner 44 is sent to a display 46 for presenting content thereon. In the embodiment shown in FIG. 3, instead of encoding the content with a watermark, an image 48 such as a visible icon, MPEG4 object, or other object-oriented representation of video is embedded in the broadcast and displayed on the display 46, it being understood that the icon/object might be in the region of the active video of a TV signal that might be overscanned and, hence, not actually seen on the TV monitor. A microprocessor 50 receives the image 48 and using it as an entering argument accesses a database 52 which can communicate, if desired, with the Internet 54. Data can be output from the microprocessor 50 to a removable media 56, e.g., a Sony Memory Stick® or Smart File® which is removably engageable with a slot in the broadcast receiver 40.

FIG. 4 shows the logic that is followed when a digital watermark is used and, hence, when the receiver 12 shown in FIG. 2 is used. Commencing at block 57, a database is accessed such as the database 17 shown in FIG. 1 that contains either data or pointers. This data or pointer is used to correlate the digital watermark to content. At block 58, the content is encoded with a digital watermark and then broadcast at block 60. At block 62, the content is decoded to obtain the watermark. Proceeding to block 64 the database 34 is accessed by the microprocessor 32 using the watermark as an entering argument. The database can be local to the broadcast receiver or remote, but in any case is preferably updatable over the Internet. Information relating to the content, such as but not limited to related Web site hyperlinks, UPC codes, advertising data, and so on are then returned from the database 52 at block 66. Alternatively, the watermark may represent the actual data itself. The information can be displayed on the display 28 and/or downloaded to the removable media 38 for engaging the media 38 with another computer to, e.g., hyperlink to a related Web site or to display the additional data on another computer or broadcast receiver.

FIG. 5 shows the logic that is followed when a visible image (for TV applications) or audio jingle (for radio applications) is embedded in the content and. When an image is used, the image can be a graphic icon such as a network logo or company logo, and it may be composited such that it is an inseparable part of the content. Alternatively, it may be in an object-oriented environment, such as MPEG4, and be a separable part of the content. In the radio context, the jingle can establish a pointer “image”.

Commencing at block 67, a database such as the database 17 shown in FIG. 1 can be accessed. The database can contain a definition table that correlates video symbols or audio jingles to data, such as Web site URLs, UPC codes, advertising data, etc. A symbol/jingle from the database is sent to block 68, wherein it is embedded in the content and then the content is broadcast at block 70. At block 72, the image 48 (or audio jingle) is analyzed by the microprocessor 50 to determine an identity of the image (or jingle). This analysis can include, e.g., obtaining an MPEG4 object directly from the image, or it can include comparing the image to the table of images/jingles in the database 52 to find a closest match. Proceeding to block 74 the database 52 is accessed by the microprocessor 50 using the image/jingle ID as an entering argument. Information relating to the content, such as but not limited to related Web site hyperlinks, UPC codes, advertising data, and so on are then returned from the database 52 at block 76. The information can be displayed on the display 46 and/or downloaded to the removable media 56 for engaging the media 56 with another computer to, e.g., hyperlink to a related Web site.

While the particular SYSTEM AND METHOD FOR EMBEDDING DATA IN BROADCAST as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

WE CLAIM:

1. A method for conveying content-related information in a broadcast signal, comprising:
imposing a non-VBI enhancement on the signal, the enhancement being correlatable to information relating to content represented by the signal.

2. The method of claim 1, wherein the non-VBI enhancement is a digital watermark, and the imposing act includes encoding the signal using the watermark, the signal being a radio signal or TV signal.

3. The method of claim 1, wherein the signal is a TV signal, the non-VBI enhancement is an image, and the imposing act includes embedding the image in the TV signal.

4. The method of claim 3, wherein the image is an icon or graphics object.

5. The method of claim 1, further comprising identifying the non-VBI enhancement at a broadcast receiver and using the enhancement in conjunction with a database.

6. The method of claim 5, wherein the identifying act includes decoding or filtering the signal to obtain a watermark.

7. The method of claim 5, wherein the identifying act includes analyzing an image embedded in the signal.

8. The method of claim 5, wherein the database holds information selected from the group including Web site hyperlinks, UPC codes, and advertising data.

9. The method of claim 5, further comprising storing information from the database on a removable media.

10. A system for conveying information pertaining to broadcast content in the content, comprising:
a broadcast component encoding the content with a digital watermark;
a broadcast receiver including a microprocessor decoding the content to retrieve the watermark; and
a database accessible by the microprocessor using the watermark to retrieve the information pertaining to broadcast content therefrom.

11. The system of claim 10, wherein the database communicates with 15 the Internet.

12. The system of claim 10, further comprising a removable media couplable to the microprocessor to receive the information pertaining to broadcast content therefrom.

13. The system of claim 10, wherein the information pertaining to broadcast content includes Web site hyperlinks, and/or UPC codes, and/or advertising data.

14. A system for conveying information pertaining to broadcast content in the content, comprising:
a broadcast component embedding at least one image in the content;
a TV including a microprocessor analyzing the image; and
a database accessible by the microprocessor using the image to retrieve the information pertaining to broadcast content therefrom.

15. The system of claim 14, wherein the database communicates with the Internet.

16. The system of claim 14, further comprising a removable media couplable to the microprocessor to receive the information pertaining to broadcast content therefrom.

17. The system of claim 14, wherein the information pertaining to broadcast content includes Web site hyperlinks, and/or UPC codes, and/or advertising data.

18. The system of claim 14, wherein the image is an icon or .mpeg object.

19. A receiver for displaying broadcast content and accessing information pertaining to the broadcast content, comprising:
a microprocessor decoding the content to retrieve a watermark therefrom; and
a database accessible by the microprocessor using the watermark to retrieve the information pertaining to broadcast content therefrom.

20. The receiver of claim 19, wherein the database communicates with the Internet.

21. The receiver of claim 19, further comprising a removable media couplable to the microprocessor to receive the information pertaining to broadcast content therefrom.

22. The receiver of claim 19, wherein the information pertaining to broadcast content includes Web site hyperlinks, and/or UPC codes, and/or advertising data.

23. A TV for displaying broadcast content and accessing information pertaining to the broadcast content, comprising:
a microprocessor analyzing an image embedded in the content; and
a database accessible by the microprocessor using the image to retrieve the information pertaining to broadcast content therefrom.

24. The TV of claim 23, wherein the database communicates with the Internet.

25. The TV of claim 23, further comprising a removable media couplable to the microprocessor to receive the information pertaining to broadcast content therefrom.

26. The TV of claim 23, wherein the information pertaining to broadcast content includes Web site hyperlinks, and/or UPC codes, and/or advertising data.

27. The TV of claim 23, wherein the image is an icon or .mpeg object.

28. The method of claim 1, wherein the enhancement is an embedded audio jingle.

29. The method of claim 1, wherein the enhancement is an embedded audio watermark.

30. The method of claim 5, wherein the identifying act includes analyzing audio for an audio jingle embedded in the signal.

31. A system for conveying information pertaining to broadcast content in the content, comprising:
a broadcast component embedding at least one audio jingle in the content;
a radio including a microprocessor analyzing the audio jingle; and
a database accessible by the microprocessor using the audio jingle to retrieve the information pertaining to broadcast content therefrom.

32. The system of claim 31, wherein the database communicates with the Internet.

33. The system of claim 31, further comprising a removable media couplable to the microprocessor to receive the information pertaining to broadcast content therefrom.

34. The system of claim 31, wherein the information pertaining to broadcast content includes Web site hyperlinks, and/or UPC codes, and/or advertising data.

35. The system of claim 31, wherein the audio jingle is an object-oriented system object.

36. A radio for playing broadcast content and accessing information pertaining to the broadcast content, comprising:
a microprocessor analyzing an audio jingle embedded in the content; and
a database accessible by the microprocessor using the audio jingle to retrieve the information pertaining to broadcast content therefrom.

37. The radio of claim 36, wherein the database communicates with the Internet.

38. The radio of claim 36, further comprising a removable media couplable to the microprocessor to receive the information pertaining to broadcast content therefrom

39. The radio of claim 36, wherein the information pertaining to broadcast content includes Web site hyperlinks, and/or UPC codes, and/or advertising data.

40. The radio of claim 36, wherein the audio jingle is an object-oriented system object.
